(19) United States
(12) Patent Application Publication
(10) Pub. No.: US 2004/0009810 A1
(43) Pub. Date: Jan. 15, 2004

(54) Video poker games with increasing payout awards

(76) Inventor: Ernest W. Moody, Las Vegas, NV (US)

Correspondence Address: JOHN EDWARD ROETHEL, 2290 S. JONES BLVD. #100, LAS VEGAS, NV, 89146, US

(21) Appl. No.: 10/617,336

(22) Filed: Jul. 10, 2003

Related U.S. Application Data
(60) Provisional application No. 60/319,388, filed on Jul. 10, 2002.

(51) Int. Cl. A63F 13/00

(52) U.S. Cl. 463/25

(57) ABSTRACT

Players are provided with higher payouts on a random basis for certain winning hand combinations that occur during the play of video poker by providing an indicator on a random basis that shows the player that certain winning combinations have increased payouts for that particular hand. The indicator is randomly activated from hand to hand so that the payouts for certain winning combinations are changed constantly. One way to indicate to the player which payouts are being used for that hand is to use colors as the indicator. The cards used can be designated with colors, such as red, white or blue, that correspond to different payouts for different winning hand combinations. Or a colored ball can be randomly selected from a hopper filled with various colored balls.

### CROSS-REFERENCE TO RELATED APPLICATION

This application is based on and claims the benefit of U.S. Provisional application Ser. No. 60/319388, filed Jul. 10, 2002, entitled “Video Poker Games with Increasing Payout Awards”.

This application relates to a method of playing video poker and more particularly to a method of playing video poker in which certain payouts in the pay table are randomly increased. Any suitable random occurrence may be used to increase these payouts, but the preferred manner is to use various colored decks of playing cards to indicate that the designated payouts have been changed.

### BACKGROUND OF THE INVENTION

A well known game of chance offered to players in most gaming casinos is video draw poker. Video draw poker is traditionally played in a single hand format. After making a wager, the player is dealt five cards face up. The player selects which cards, if any, the player wishes to hold, the unheld cards are discarded and replacement cards are dealt for the discarded cards. The final five card hand is analyzed to determine its poker hand ranking and the player is paid for winning poker hand rankings based on the amount of the player§s wager. A pay table is displayed to the player showing the amounts that the player can win based on the poker hand ranking achieved by the player and the amount wagered by the player.

U.S. Pat. No. 5,823,873 (Moody) (the disclosure of which is incorporated herein by this reference) describes TRIPLE PLAY DRAW POKER® which is an electronic video gaming machine and method in which the player may play multiple hands at the same time. In the most successful commercial version of TRIPLE PLAY DRAW POKER®, the player makes a wager for each of three separate hands to be played by the player. One hand of five cards is dealt all face up. The player selects none, one or more of the face up cards from the first hand as cards to be held. The cards that are held are reused from the first hand into all of the other hands. Replacement cards for the non-selected cards are dealt into the first hand and additional cards are then dealt to the first hand, if needed, so that the first hand has five cards. Additional cards are also dealt to all of the other hands so that each hand is a five card hand. The poker hand ranking of each five card hand is determined row by row. The player is then paid for any winning poker hands based on a pay table and the amount of the player's wager.

Another multiple hand poker game is disclosed in U.S. Pat. No. 6,050,568 (Hachquet) and U.S. Pat. No. 6,135,883 (Hachquet), the disclosure of each of these patents being incorporated herein. In the method of play disclosed in the Hachquet patents, a player is dealt two identical poker hands. The player may discard and draw replacement cards independently in each hand so that the player may, if he were so inclined, employ a different hold strategy for each hand. Winning hands will receive a payout according to a pay table.

The casino video poker market is very competitive and gaming establishments are continuously looking for new and exciting forms of video poker to attract and keep players. It is desirable to offer the player the opportunity to receive larger payouts in order to encourage the players to play the video poker gaming machines.

It is an object of the present invention to provide players with higher payouts on a random basis for certain winning hand combinations. This can be accomplished by providing an indicator on a random basis that shows the player that certain winning combinations have increased payouts for that particular hand. The indicator is randomly activated from hand to hand so that the payouts for certain winning combinations are changed constantly.

It is a further object of the present invention to use colors as the indicator. For example, the cards used in video poker can be designated with colors, such as red, white or blue, that correspond to different payouts for different winning hand combinations.

It is a feature of the present invention to provide the player with changing winning payouts for certain winning hand combinations. The changing payouts are displayed on a random basis prior to the play of each hand. This feature can be applied to both single hand poker games and multiple hand poker games.

It is an advantage of the present invention that the player will have the opportunity to win larger payouts on a random basis. This adds additional excitement to the play of video poker by combining the skill aspects of video poker with the chance aspects of the randomly changing values for certain winning poker hand.

Other objects, features and advantages of the present invention will become apparent from a consideration of the following detailed description.

### SUMMARY OF THE INVENTION

Players are provided with higher payouts on a random basis for certain winning hand combinations that occur during the play of video poker. This can be accomplished by providing an indicator on a random basis that shows the player that certain winning combinations have increased payouts for that particular hand. The indicator is randomly activated from hand to hand so that the payouts for certain winning combinations are changed constantly.

One way to indicate to the player which payouts are being used for that hand is to use colors as the indicator. For example, the cards used in video poker can be designated with colors, such as red, white or blue, that correspond to different payouts for different winning hand combinations. When the cards are initially dealt, the back of the cards or the border area of the cards can have a distinct color which is associated with a particular pay table.

### DETAILED DESCRIPTION OF THE PREFERRED EMBODIMENTS

The present invention can be applied to any form of video poker including both single hand video poker and multiple hand video poker.

In the present invention as applied to single hand poker, a player makes a wager to be able to play a hand of cards.

At the time the cards are dealt (or prior to the deal of the cards), a randomized selector is activated to determine which of two or more pay tables will be used for that round of play. In the preferred embodiment of the present invention, one of three pay tables will be selected. Each pay table has a different theoretical game return. For example, BLUE Table 1 can be used that has a theoretical game return of 96.15%:

TABLE 1
BLUE

| DRAW POKER | NUMBER OF COINS BET | | | | |
|---|---|---|---|---|---|
| POKERHAND | 1 | 2 | 3 | 4 | 5 |
| ROYAL FLUSH | 800 | 1600 | 2400 | 3200 | 4000 |
| STRAIGHT FLUSH | 50 | 100 | 150 | 200 | 250 |
| FOUR-OF-A-KIND | 25 | 50 | 75 | 100 | 125 |
| FULL HOUSE | 7 | 14 | 21 | 28 | 35 |
| FLUSH | 5 | 10 | | | |
| STRAIGHT | 4 | 8 | | | |
| THREE-OF-A-KIND | 3 | 6 | | | |
| TWO PAIR | 2 | 4 | | | |
| JACKS OR BETTER | 1 | 2 | | | |

WHITE Table 2 can be used that has a theoretical game return of 104.89%:

TABLE 2
WHITE

| DRAW POKER | NUMBER OF COINS BET | | | | |
|---|---|---|---|---|---|
| POKERHAND | 1 | 2 | 3 | 4 | 5 |
| ROYAL FLUSH | 1600 | 3200 | 4800 | 6400 | 8000 |
| STRAIGHT FLUSH | 100 | 200 | 300 | 400 | 500 |
| FOUR-OF-A-KIND | 50 | 100 | 150 | 200 | 250 |
| FULL HOUSE | 7 | 14 | 21 | 28 | 35 |
| FLUSH | 5 | 10 | 15 | 20 | 25 |
| STRAIGHT | 4 | 8 | 12 | 15 | 20 |
| THREE-OF-A-KIND | 3 | 6 | 9 | 12 | 15 |
| TWO PAIR | 2 | 4 | 6 | 8 | 10 |
| JACKS OR BETTER | 1 | 2 | 3 | 4 | 5 |

RED Table 3 can be used that has a theoretical game return of 113.86%:

TABLE 3
RED

| DRAW POKER | NUMBER OF COINS BET | | | | |
|---|---|---|---|---|---|
| POKERHAND | 1 | 2 | 3 | 4 | 5 |
| ROYAL FLUSH | 2400 | 4800 | 7200 | 9600 | 12000 |
| STRAIGHT FLUSH | 150 | 300 | 450 | 600 | 750 |
| FOUR-OF-A-KIND | 75 | 150 | 225 | 300 | 375 |
| FULL HOUSE | 8 | 16 | 24 | 32 | 40 |
| FLUSH | 5 | 10 | 15 | 20 | 25 |
| STRAIGHT | 4 | 8 | 12 | 16 | 20 |
| THREE-OF-A-KIND | 3 | 6 | 9 | 12 | 15 |
| TWO PAIR | 2 | 4 | 6 | 8 | 10 |
| JACKS OR BETTER | 1 | 2 | 3 | 4 | 5 |

Any suitable pay tables may be used and each pay table can have any suitable theoretical game return.

The randomized selector will select one of either the BLUE, WHITE or RED pay tables to be used during the round of play. Any suitable manner of randomly selecting one of the pay tables can be used. In one example, the backs of the playing cards and/or the borders of the playing cards are provided with a suitable coloring of either blue, white or red. The color is then associated with the appropriate pay table. When the cards are dealt, the computer controls randomly select one of the colors which is then associated with the playing cards dealt to the player to indicate which pay table is being used for that round of play.

Another way of randomly selecting the colors would be to use a hopper filled with different colored balls from which is selected the color to be used in that round of play. Since the video poker machine uses a video display to show the playing of the game, the player can be presented with a video display of a hopper from which the colored ball is selected.

Any desirable manner of displaying the color selection to the player can be done either at the time the cards are dealt or prior to the deal of the cards. Alternatively, the color could also be selected after the deal of the cards, but before the player begins the actual play of the hand by selecting which cards to hold.

The colors can be distributed in any weighed grouping so that the overall game return is maintained at an acceptable level for the operator of the gaming establishment. For example, with reference to the BLUE, WHITE and RED pay tables shown above, the color distribution can be 21 BLUE, 6 WHITE and 3 RED. Based on the individuals game returns shown above, this color distribution would yield an overall game return of 99.61.%. Any suitable overall game return can be used.

After the color has been selected, the play continues as in conventional video poker, the player is dealt five cards face up (unless the cards have already been dealt). These first five cards are the player's initial hand or starting hand.

The player selects which cards, if any, the player wishes to hold from his initial hand. The unheld cards are discarded and replacement cards are dealt for the discarded cards. The final five card hand is analyzed to determine its poker hand ranking and the player is paid for winning poker hand rankings based on the amount of the player's wager. Any winning poker hand combination is paid to the player in accordance with the pay table associated with the color selected.

The method of the present invention can also be applied to multiple hand poker games. U.S. Pat. No. 5,823,873 (Moody) (the disclosure of which is incorporated herein by this reference) describes TRIPLE PLAY DRAW POKER® which is an electronic video gaming machine and method in which the player may play multiple hands at the same time. In the most successful commercial version of TRIPLE PLAY DRAW POKER®, the player makes a wager for each of three separate hands to be played by the player. One hand of five cards is dealt all face up. The player selects none, one or more of the face up cards from the first hand as cards to be held. The cards that are held are reused from the first hand into all of the other hands. Replacement cards for the non-selected cards are dealt into the first hand and additional cards are then dealt to the first hand, if needed, so that the first hand has five cards. Additional cards are also dealt to all of the other hands so that each hand is a five card hand. The poker hand ranking of each five card hand is determined row by row. The player is then paid for any winning poker hands based on a pay table and the amount of the player's wager.

At the beginning of each round of a multiple hand poker game, the player selects the number of hands the player wishes to play. A color is then randomly selected for that round of play. Whatever color is selected can be used with all of the multiple hands to be played by the player.

Alternatively, each of the multiple hands to be played by the player can have it shown color randomly selected and associated therewith. The mathematical game return is the same whether a single color is associated with all hands or if each hand has its own randomly selected color.

While the pay tables shown above are based on regular Draw Poker format, the present invention can also be used with other pay tables for the other variations of draw poker, such as Deuces Wild Poker, Bonus Poker, Double Bonus Poker, Double Double Bonus Poker, Triple Bonus Poker, Joker's Wild Poker or any of the myriad of video poker formats that have been developed. Each of these video poker formats uses various arrangements of poker hand rankings as winning combinations and they use various payout amounts for the poker hand rankings. The method of the present invention can be applied to any of the various video poker formats discussed above.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims.

What is claimed is:

1. A method of playing a conventional single hand video poker game in which different pay tables are randomly designated comprising:
a) providing at least two pay tables, each pay table having a different payout for at least one of a winning hand combination;
b) designating which pay table is to be used in the play of the video poker game;
c) playing the conventional video poker game; and
d) awarding the player a payout for a winning hand combination from the designated pay table.

2. The method of claim 1 in which each pay table has associated therewith a color and the color of the designated pay table is displayed to the player.

3. The method of claim 2 in which the color of the designated pay table is displayed to the player by associating the color with playing cards used in the method of play.

4. The method of claim 1 in which the designated pay table is randomly selected.

5. The method of claim 1 in which each pay table has a different theoretical game return.

6. The method of claim 5 in which at least one of the pay tables has a theoretical game return in excess of 100%.

7. The method of claim 6 in which the designated pay table is randomly selected using a weighting system so that the overall game return is less than 100%.

8. A method of playing a conventional multiple hand video poker game in which different pay tables are randomly designated comprising:
a) providing at least two pay tables, each pay table having a different payout for at least one of a winning hand combination;
b) designating at least one of the pay tables as a pay table to be used in the play of the video poker game;
c) playing the conventional video poker game; and
d) awarding the player a payout for a winning hand combination from the designated pay table.

9. The method of claim 8 in which each pay table has associated therewith a color and the color of the designated pay table is displayed to the player.

10. The method of claim 9 in which the color of the designated pay table is displayed to the player by associating the color with playing cards used in the method of play.

11. The method of claim 8 in which the designated pay table is randomly selected.

12. The method of claim 8 in which each pay table has a different theoretical game return.

13. The method of claim 12 in which at least one of the pay tables has a theoretical game return in excess of 100%.

14. The method of claim 13 in which the designated pay table is randomly selected using a weighting system so that the overall game return is less than 100%.

15. The method of claim 8 in which a single pay table is designated to be used with each of multiple hands.

16. The method of claim 8 in which at least a first pay table is designated to be used with some of the multiple hands and at least a second pay table is designated to be used with others of the multiple hands.

17. The method of claim 8 in which the multiple hands comprise at least two hands and a single pay table is designated to be used with each of multiple hands.

18. The method of claim 8 in which the multiple hands comprise at least two hands and a first pay table is designated to be used with a first of the multiple hands and a second pay table is designated to be used a second of the multiple hands.
